(19) United States
(12) Patent Application Publication
(10) Pub. No.: US 2009/0037226 A1
(43) Pub. Date: Feb. 5, 2009

(54) UTILIZING LIFE INSURANCE TO BENEFIT A CHARITY

(76) Inventor: Sam Radin, New York, NY (US)

Correspondence Address: FISH & RICHARDSON P.C., P.O. BOX 1022, MINNEAPOLIS, MN, 55440-1022, US

(21) Appl. No.: 11/831,565

(22) Filed: Jul. 31, 2007

(51) Int. Cl. G06Q 40/00

(52) U.S. Cl. 705/4

(57) ABSTRACT

Funding a charity includes identifying an individual whose life represents an insurable interest to the charity, obtaining an insurance policy to cover the identified individual's life, funding premiums for the insurance policy from a funding source other than the insured individual and paying proceeds from the insurance policy for the benefit of the charity, pursuant to an agreement made approximately when the insurance policy was obtained.

### BACKGROUND

A charitable organization (hereinafter a “charity”) is generally an organization established for one or more charitable purposes. Depending on the charitable purpose, individuals and/or organizations sometimes may donate cash, services, clothing, toys or food to the charity. Indeed, life insurance policies and/or proceeds are sometimes donated to a charity.

A life insurance policy is a contract between the policy's owner and an insurer, whereby the insurer generally agrees to pay a sum of money to a beneficiary upon the death of the individual insured under the policy. In return, the policy owner generally agrees to pay a stipulated amount called a premium at regular intervals.

### SUMMARY OF THE INVENTION

According to one aspect, a method of funding a charity includes identifying an individual in whose life the charity has an insurable interest, obtaining an insurance policy to cover the identified individual's life, funding premiums for the insurance policy from a funding source other than the insured individual and directing proceeds from the insurance policy for the benefit of the charity, pursuant to an agreement made approximately when the insurance policy was obtained.

The proceeds typically are paid upon the insured individual's death and usually include a basic insurance amount, plus a sum of the premiums paid as of the date that the proceeds are available. In some instances, the proceeds also include interest on the sum of the premiums paid. The proceeds may be paid upon a sale of the insurance policy by the charity to a third party. The charity typically is designated a beneficiary of the insurance policy.

In some implementations, the method includes quantifying a value associated with the insurable interest and structuring the insurance policy in accordance with the quantified value. In such instances, the life insurance policy may be structured so that, upon the death of the insured individual, the charity receives sufficient capital to continue receiving the quantified value.

According to certain implementations, the insurable interest is based on the insured individual's history of contributions to the charity. Those contributions may include periodic financial donations and/or volunteer services provided to the charity. If the contributions were services volunteered, then the method may include quantifying the insurable interest by assigning a value per unit of time to the services volunteered, estimating how many units of time were volunteered by the insured individual and calculating a average value per unit of time received by the charity based on the services volunteered.

The method typically includes evaluating whether the individual is insurable. That may include considering at least one of the characteristic from the following group: the individual's age, the individual's health and an estimated life expectancy for the individual. In some instances, the funding source is an entity other than the charity.

In another aspect a method of financing a charity's capital project includes issuing a first set of municipal bonds to provide a funding source for insurance policy premiums, issuing a second set of municipal bonds to finance a capital project associated with the charity's charitable purpose and pledging the life insurance proceeds to pay holders of the second set of municipal bonds.

In some implementations, the method further includes identifying an individual whose life represents an insurable interest to the charity, obtaining an insurance policy to cover the identified individual's life and funding the insurance policy premiums with funds from the issuance of the first set of municipal bonds. The charity is a direct or indirect beneficiary of the insurance policy so that policy proceeds are paid to the charity or to a trust for its benefit.

In yet another aspect, a method of facilitating the funding of a charity includes identifying an individual whose life represents an insurable interest to the charity, obtaining an insurance policy to cover the identified individual's life on behalf of the charity, arranging for the funding of insurance policy premiums from a funding source other than the insured individual and arranging for the payment of proceeds from the insurance policy for the benefit of the charity. In some implementations, the method also includes arranging for the charity or a trust for its benefit to be designated a beneficiary of the insurance policy.

Certain implementations include soliciting competitive bids on behalf of the charity from more than one insurance company and assisting the charity to evaluate bids received. In some implementations, the method includes obtaining competitive bids from multiple life settlement providers to purchase an interest in the insurance policy and assisting the charity to evaluate bids received.

Arranging for the payment of proceeds from the insurance policy for the benefit of the charity typically is performed approximately at the same time that the insurance policy is obtained.

In some implementations, one or more of the following advantages are present.

For example, the number of individuals who decide to donate life insurance proceeds to a charity will likely increase. As used herein, the term “donate life insurance” should be construed broadly to mean giving or otherwise providing life insurance to charity. Since, in some implementations, an insured individual would not be required to pay policy premiums, the pool of potential candidates available to donate life insurance proceeds to a charity is increased.

Additionally, some implementations reduce borrowing costs that a charity would normally incur. By implementing the techniques disclosed herein such borrowing costs may be reduced. This may enhance a charity's ability to undertake significant capital projects.

The details of one or more embodiments of the invention are set forth in the accompanying drawings and the description below. Other features and advantages of the invention will be apparent from the description and drawings, and from the claims.

### BRIEF DESCRIPTION OF THE DRAWINGS

FIG. 1 is a schematic representation of entities engaged in donating or otherwise providing life insurance proceeds to a charity.

FIG. 2 is a flowchart of an implementation a method for donating life insurance proceeds to the charity.

FIG. 3 is another schematic representation of entities engaged in donating life insurance proceeds to a charity.

FIG. 4 is yet another schematic representation of entities engaged in donating life insurance proceeds to a charity.

FIG. 5 is still another schematic representation of entities engaged in donating life insurance proceeds to a charity.

FIG. 6 is a schematic representation of an insurance service provider obtaining competitive bids from multiple life settlement providers on behalf of a charity.

FIG. 7 is a schematic representation of entities engaged in using life insurance to facilitate financing a charity's capital project.

FIG. 8 is a flowchart of a flowchart of an implementation of a method for financing a charity's capital project.

### DETAILED DESCRIPTION

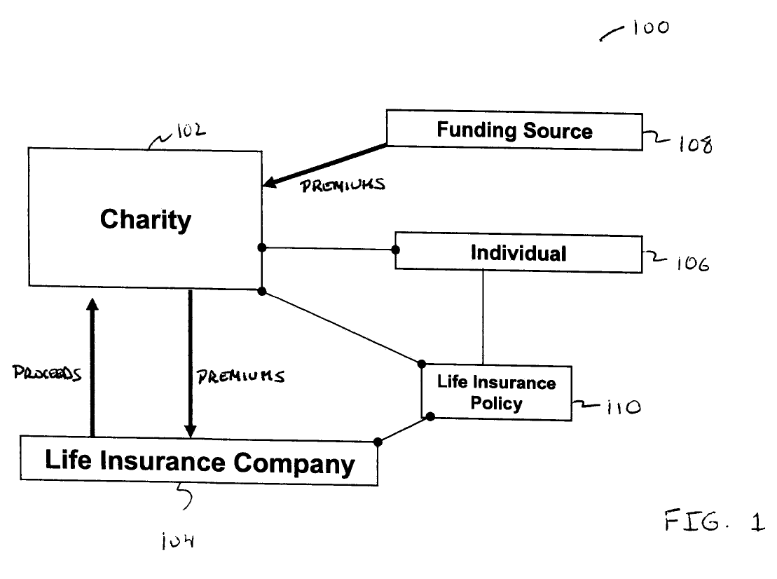

FIG. 1 is a schematic representation of entities 100 engaged in donating proceeds from a life insurance policy 110 to a charity 102. The illustrated parties include the charity 102, a life insurance company 104, an individual 106 to be insured and a funding source 108.

In some implementations, the charity 102 may be a corporation, trust or association established either entirely or partially for a charitable purpose. It also may be a non-profit organization. In certain instances, the charity 102 is an entity that receives “charitable contributions” as defined by Section 170(c) the Internal Revenue Code. The life insurance company 104 is an organization that sells life insurance policies. The life insurance company 104 may perform other functions as well. Typically, the funding source 108 is a different entity than the individual 106 to be insured. The funding source 108 is a different entity than the insurance company as well. The funding source 108 can be an individual or an organization, such as a company, that donates or otherwise makes available funds for use by the charity 102.

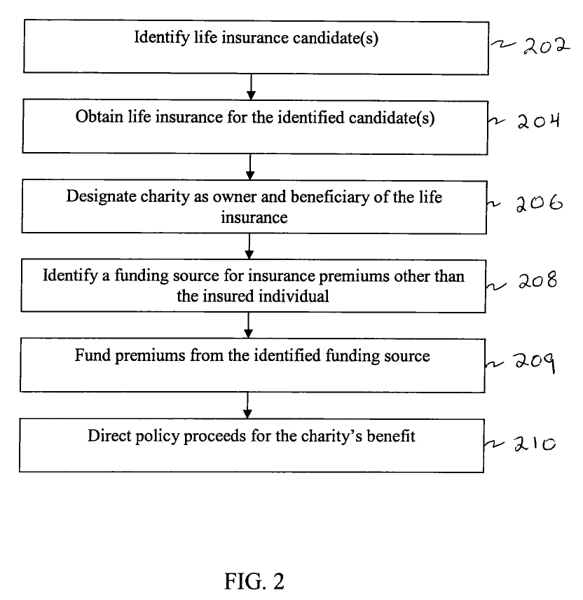

FIG. 2 is a flowchart of an implementation of a method for donating or otherwise providing life insurance death benefits to the charity 102.

As illustrated, the charity 102 identifies one or more life insurance candidates (e.g., individual 106) (block 202). Typically, this includes reviewing a list of individuals who have a somewhat consistent history of contributing money and/or volunteering services to the charity 102. The list may be filtered to identify those individual most likely to enter into an agreement to donate life insurance proceeds to the charity 102. Filtering the list may include considering a number of characteristics including, for example, gender, occupation, employment status, household income, net worth, country of origin, current location of residence, history of contributions or service to the charity.

As a particular example, the list may be filtered to identify only those individuals who have a net worth of over $1,000,000 and have historically donated time and/or money to the charity 102 valued at more than about $5,000 per year.

Typically, the charity 102 considers which of the listed individuals meet the criteria to be insured. Determining whether an individual is healthy enough to be insured can involve reviewing the individual's medical history and, in some cases, subjecting the individual to a medical examination. The details of the medical examination may vary depending, for example, on the individuals age and the amount of insurance coverage desired. Typical medical examinations can include a basic physical exam, urine specimen, blood work, resting electrocardiogram (EKG) and/or an exercise or treadmill EKG.

Often, the charity 102 has limited access to information about an individual's health. Indeed, in most instances, such information is limited to mere casual observations or common knowledge about an individual's health. Moreover, the charity 102 typically lacks any medical expertise, thereby making meaningful medical assessment virtually impossible. Therefore, it is not unusual for this step to be taken with the assistance of an insurance services provider and doctors that may work for such provider. In some implementations, the insurance services provider obtains authorization from an individual to access information about his/her medical history. The insurance services provider also may review the medical history and submit such history to insurance carriers, with comments, as appropriate. Ultimately, the individual's health qualification is evaluated by an insurance company that would issue a policy insuring the life of the individual.

The charity 102 also considers the age of the listed individuals. Sometimes an individual's eligibility to participate may be conditioned on the individual having reached some minimum age (e.g., 70 years old). Imposing such a condition may be desirable to the charity 102 and to the funding source 108 for at least the following reasons. First, the average amount of time that the charity 102 will have to wait before the policy's death benefits become available is minimized. Additionally, having an expected payoff in the not-too-distant future may facilitate selling the policy (or an interest therein) to a third party as a life settlement.

A life settlement is a financial transaction in which a policy owner (here, the charity 102) sells an unwanted or unneeded policy to a third party for an amount typically greater than the policy's cash surrender value offered by the life insurance company. A policy's “cash surrender value” is the amount of money a policyholder would receive if the policy were terminated (i.e., surrendered) before the insured individual dies. When a third party purchases a life settlement, it becomes the policy's owner and beneficiary and assumes responsibility for making timely premium payments.

The charity 102 considers and demonstrates that it has an insurable interest in the life of each individual to be insured. Before a policy is issued for an individual, the insurance company also considers whether the charity 102 has an insurable interest in the individual's life. In general, a charity 102 may have an insurable interest in an individual's life if, upon the individual's death, the charity 102 would suffer a financial loss. That may be the case if, for example, an individual periodically has been contributing either time or money to the charity 102 and such contributions would cease upon the individual's death.

If, for example, an individual periodically has been contributing money to the charity 102, then the charity 102 may have an insurable interest in continuing to receive such periodic contributions after the individual dies. In that situation, the insurance policy's death benefits would provide sufficient capital to ensure the charity's 102 continued receipt of equal periodic contributions from the investment earnings of such capital amount. More particularly, the death benefits would provide a capital base sufficiently large to invest at an assumed rate of return to replace those periodic contributions without invading the principal.

If, for example, an individual has been contributing $50,000 per year to a charity (e.g., 102) and those contributions would otherwise cease upon the individual's death, then the charity 102 would have an insurable interest in continuing to receive those periodic contributions after the individual dies. In that instance, insurance may provide a capital payout sufficient so that the charity 102 will continue to receive $50,000 per year in perpetuity. Assuming an annual interest rate of 5%, the requisite capital to perpetuate such receipts would be approximately $1,000,000.

Alternatively, if an individual has been regularly contributing services to the charity (e.g., 102), then the charity might have an insurable interest measured by the cost of hiring an individual to perform such services after the individual dies. In that situation, an estimated value could be assigned to the services provided. An insurance policy can be structured to provide the charity with sufficient capital to pay for comparable services in perpetuity.

As an example, if an attorney with a billing rate of $200 per hour has been volunteering legal services of approximately ten hours per month to the charity 102, then those services might be valued at approximately $2,000 per month ($200 per hour*10 hours per month=$2,000 per month) or $24,000 per year. Assuming an annual interest rate of about 5%, the requisite capital to pay for $24,000 per year in legal services in perpetuity would be approximately $480,000.

In some situations an individual may have been regularly contributing a combination of money and services to a charity (e.g., 102). In those situations, both types of contributions may be considered in determining the charity's 102 insurable interest in the individual and, therefore, the death benefits that would be due to the charity under a resulting insurance policy.

In some implementations, the charity 102 conducts a study to estimate the life expectancy of listed individuals 106 being considered for insurance. Typically, the life expectancy study is based on actuarial sciences and involves consideration of the individual's medical status, including, without limitation, his/her medical history and recent medical examinations may be considered in the life expectancy study. Other lifestyle-type factors (e.g., level of activity, tobacco use, occupation and location) may be considered in the life expectancy study as well. Often, the charity 102 has limited access to such information. Accordingly, this step might be taken with assistance, for example, from an independent life insurance services provider (not shown in FIG. 1). The actual study typically may be conducted by an independent life expectancy company, which produces a life expectancy certificate providing an estimate of the remaining life expectancy of the insurance candidate.

In some implementations, results of the life expectancy study may be used to predict a present value of the policy if it were to be sold as a life settlement. This may help the charity and/or third party funding sources evaluate the desirability of various policies.

Results from the life expectancy study also may be used in negotiating an underwriting classification to be assigned to the insurance candidate by the insurance company. In some implementations, the life insurance services provider conducts an independent life expectancy study before a policy is issued on an individual.

The life insurance company may assign an underwriting classification to an individual (e.g., 106) that implies a longer life expectancy than indicated by the life expectancy study. This may create positive arbitrage and, therefore, enhance the intrinsic value of the policy to be issued. If the insurance company 104 projects a longer life expectancy than the life expectancy company, the insurer may have underpriced the policy. If such were the case, the premiums would not accurately reflect the risk of early death. Accordingly, if death were to occur earlier than predicted by the insurer, the policy would produce a return on investment that was greater than that predicted by the insurer.

Of course, the charity 102 also considers whether listed individuals are willing to be insured in order to provide life insurance proceeds to the charity 102. This may involve conversations, and various other correspondence with the listed individuals.

After one or more life insurance candidates have been identified, the charity 102 obtains (block 204) life insurance policies for each of the identified candidates. Obtaining such life insurance may entail seeking out competitive bids from multiple insurance companies. After bids are selected, policies are issued and the charity is designated (block 206) as the beneficiary (and typically, owner) thereof.

According to the illustrated implementation, the charity 102 then identifies 208 a funding source 108, to pay the insurance premiums. Typically, the funding source 108 is known before any of the insurance design and underwriting processes begin. The funding source 108 typically is a different entity than the insured individual 106. In some implementations, the funding source 108 for the policy premiums may be the charity 102 itself. However, more frequently, the funding source 108 is an entity other than the charity 102 as well. The funding source 108 may be an individual or an entity interested in donating to the charity 102.

Once a funding source 108 has been selected and a policy is in place, the charity 102 funds the policy premiums with money from the funding source 108 (block 209).

In some implementations, the funding source 108 contributes premium payments to the charity 102 as a tax deductible gift. In those implementations, the funding source 108 generally does not retain an interest in the policy 110. If however, the funding source 108 does retain an interest in the policy, then some or all of the premium contributions may not be tax deductible.

In some implementations, the funding source 108 contributes funds using a split-dollar arrangement. A split-dollar arrangement is a funding arrangement, pursuant to which the funding source 108 advances the premiums, while retaining an interest in the policy equal to the greater of (i) the premiums paid or (ii) the policy cash value. In the event of the insured's death, the funding source 108 recovers such interest from the insurance proceeds. In other split-dollar arrangements the premium payments provided by the funding source 108 are treated as loans. In such a case, the funding source 108 may have a security interest in the policy equal to the greater of (i) the cumulative premiums paid or (ii) the policy cash value. In addition, the funding source is entitled to interest in respect of the loan.

If the funding source 108 is reimbursed for premiums paid, the reimbursement may or may not include interest. If the funding source 108 is repaid without interest, then reimbursement generally carries no tax consequences for the funding source 108. If the funding source is reimbursed with interest, however, then reimbursement generally does carry tax consequences for the funding source 108. Such tax consequences can depend on whether reimbursement results from a sale of the policy as a life settlement or from the death of the insured individual. If the repayment results from sale of the policy as a life settlement, then the interest may be taxable to the funding source 108. If repayment results from death benefits under the policy, then the interest may not be taxable to the funding source 108.

The illustrated method also includes directing policy proceeds for the benefit of the charity 102 (block 210). The policy proceeds are so directed pursuant to an agreement made at the time that the life insurance policy is obtained. If, for example, there is a split-dollar arrangement, a split-dollar agreement memorializing the transaction and setting forth the parties' respective rights is executed at the inception of the policy. In that situation, the agreement to direct policy proceeds for the benefit of the charity may be part of the split-dollar agreement. More generally, when the life insurance policy is first established, the parties (i.e., the insured individual and the charity) enter into an agreement, pursuant to which policy proceeds will be directed to the benefit of the charity. It is possible that such an agreement or instruments relating thereto may be recorded at the insurance company against the insurance policy.

In some implementations, the policy proceeds are paid directly to the charity. In some implementations, the policy proceeds are used in other ways to benefit the charity. In some instances the proceeds are directed to the charity as an endowment.

Policy proceeds can include: death benefits payable upon the insured individual's death, a cash surrender payment payable upon surrender of the policy to the insurance company or cash from the sale of the policy as a life settlement. A policy's death benefits typically include a basic policy amount. In some implementations, a policy's death benefit may include the sum of premiums paid to date by the funding source 108 and, in some instances, interest applied to the amount of such premiums paid.

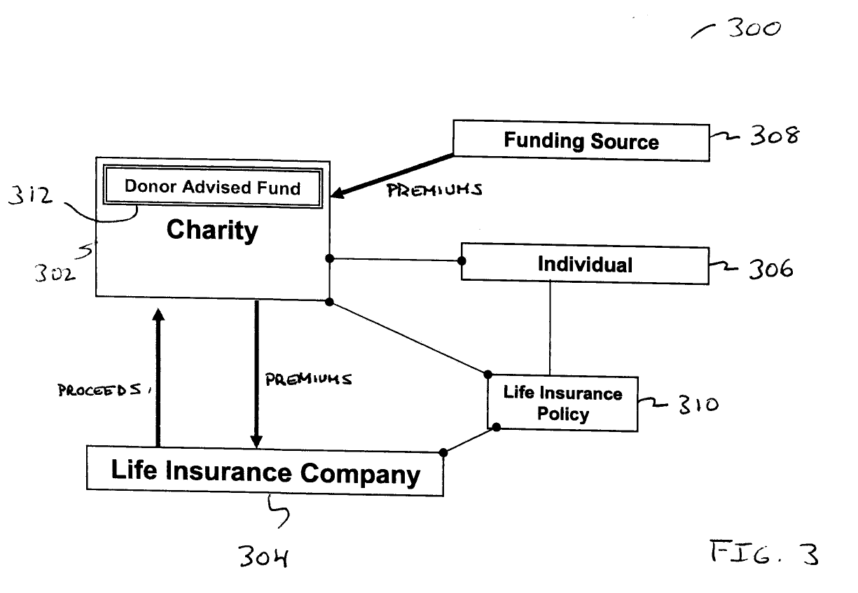

FIG. 3 is another schematic representation of entities 300 engaged in a process of donating proceeds from a life insurance policy 310 to a charity 302. The illustrated entities 300 include the charity 302, a life insurance company 304, an insurable individual 306 and a funding source 308.

The illustrated entities 300 are similar to the entities shown in FIG. 1 except the charity 302 in FIG. 3 has a donor advised fund 312 that it uses to pay the policy premiums. The donor advised fund 312 receives funds from the funding source 108. In general, a donor advised fund (e.g., 312) is a charitable giving vehicles set up under the tax umbrella of a charity (e.g., 302). A donor advised fund is a relatively easy-to-establish, low cost, flexible vehicle for charitable giving as an alternative to direct giving or creating a private foundation. Donors (e.g., funding donor 308) typically realize administrative convenience, cost savings and tax advantages by conducting their grant-making through a donor advised fund (e.g., 312).

In the illustrated arrangement, the funding source 308 advises the charity 302 whether to use money from the donor advised fund 312 to finance premiums on life insurance policies (e.g., 310). Such advice may range from giving general consent that such investments are acceptable to helping the charity 302 identify particular instances of acceptable investment opportunities. The funding source 308 may condition payment of insurance premiums on those payments being refunded to the donor advised fund 312 in the event that the policy is sold or the insured individual dies. Additionally, the funding source 308 may condition payment of insurance premiums on interest being paid to the donor advised fund 312 when the policy is sold or when the insured individual dies. The possibility of earning interest, in those instances, may be attractive to the charity's management because of management's fiduciary duties to the charity.

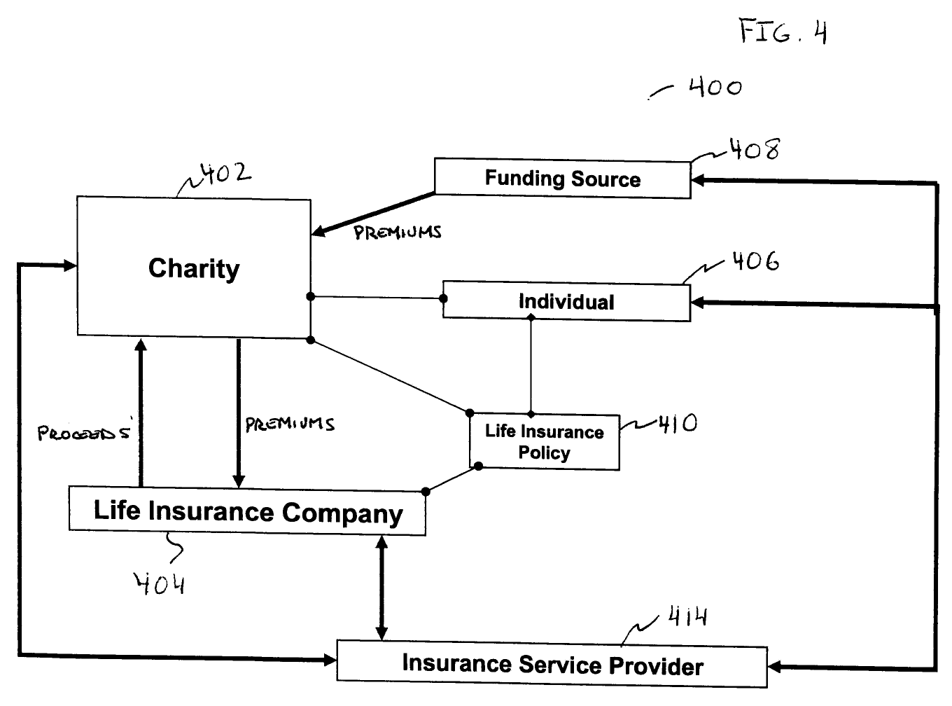

FIG. 4 is an alternative schematic representation of entities 400 engaged in donating proceeds from a life insurance policy 410 to a charity 402. The illustrated entities 400 are similar to the entities shown in FIG. 1 except the entities 400 in FIG. 4 include an insurance service provider 414.

In the illustrated implementation, the insurance service provider 414 interacts with the charity 402, the life insurance company 404, the individual 406 to be insured, and the funding source 408. The insurance service provider 414 essentially acts as a middleman, coordinating the activities of each entity it interacts with in order to facilitate the donation process.

In a typical implementation, the insurance service provider 414 works with the charity 402 to identify individuals who are willing to consider and interested in making life insurance proceeds available to the charity by agreeing to be insured for its benefit. This may involve reviewing lists of potential candidates, filtering those lists based on a number of criteria, corresponding with potential candidates on behalf of the charity 402 to determine interest and willingness and coordinating medical evaluations of potential candidates. Once a suitable insurance candidate is selected, the insurance service provider 414 may help the charity obtain a life insurance policy for that candidate. This may involve obtaining competitive bids from multiple life insurance companies 404 and helping the charity 402 evaluate the bids it receives. The insurance service provider 414 also may process life insurance applications for the insurance candidates on behalf of the charity 402.

The insurance service provider 414 also may help the charity identify funding sources (e.g., 408). This may involve reviewing a list of past donors to the charity and filtering the list based on specified criteria. The insurance service provider 414 may correspond with potential funding sources 408 on behalf of the charity 402.

The insurance service provider 414 can coordinate the exchange of funds between various entities. For example, the insurance service provider 414 may send donation reminders to the funding donor. Additionally, the insurance service provider 414 may assist the charity 402 in processing the policy proceeds it receives, for example, upon an insured individual's death.

The insurance service provider 414 can help the charity 402 evaluate whether to sell a policy as a life settlement. If it is determined that a policy should be sold as a life settlement, the insurance service provider may assist the charity in obtaining competitive bids and may assist the charity in evaluating the bids received.

The insurance service provider 414 may be involved in a number of other administrative and substantive roles. In a typical situation, an insurance service provider 414 may work with a number of different charities 402 at the same time.

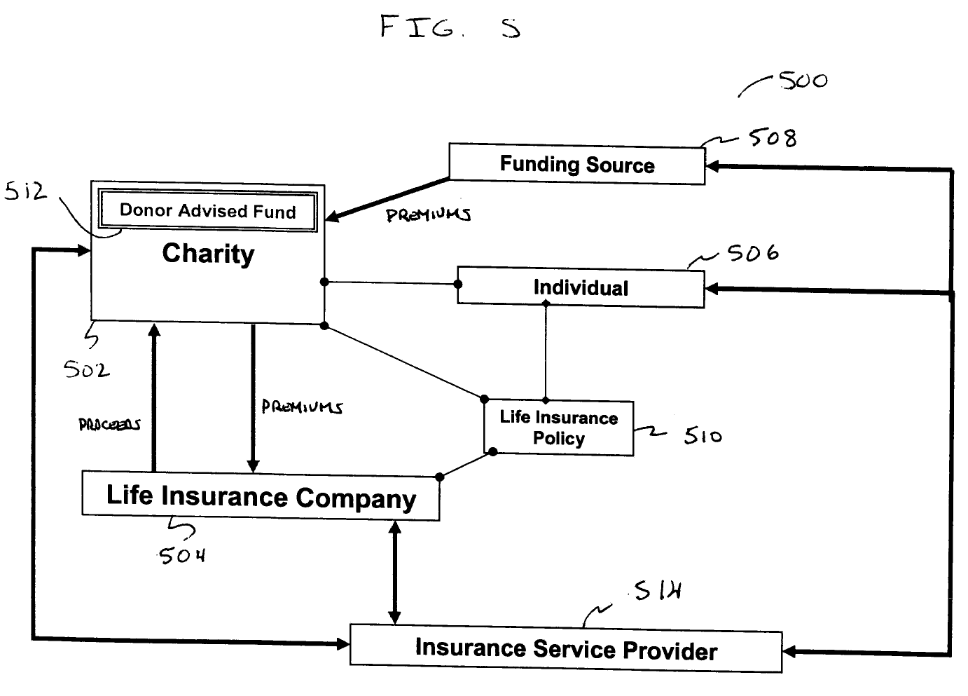

FIG. 5 is a schematic representation of entities 500 engaged in yet another process of donating proceeds from a life insurance policy to a charity 502. The illustrated entities 500 include the charity 502, a life insurance company 504, an individual 506 to be insured and a funding source 508. The illustrated entities 500 are similar to the entities shown in FIG. 4 except the charity 502 in FIG. 5 has a donor advised fund 512 that it uses to pay the policy premiums. The donor advised fund 512 receives funds from the funding source 508.

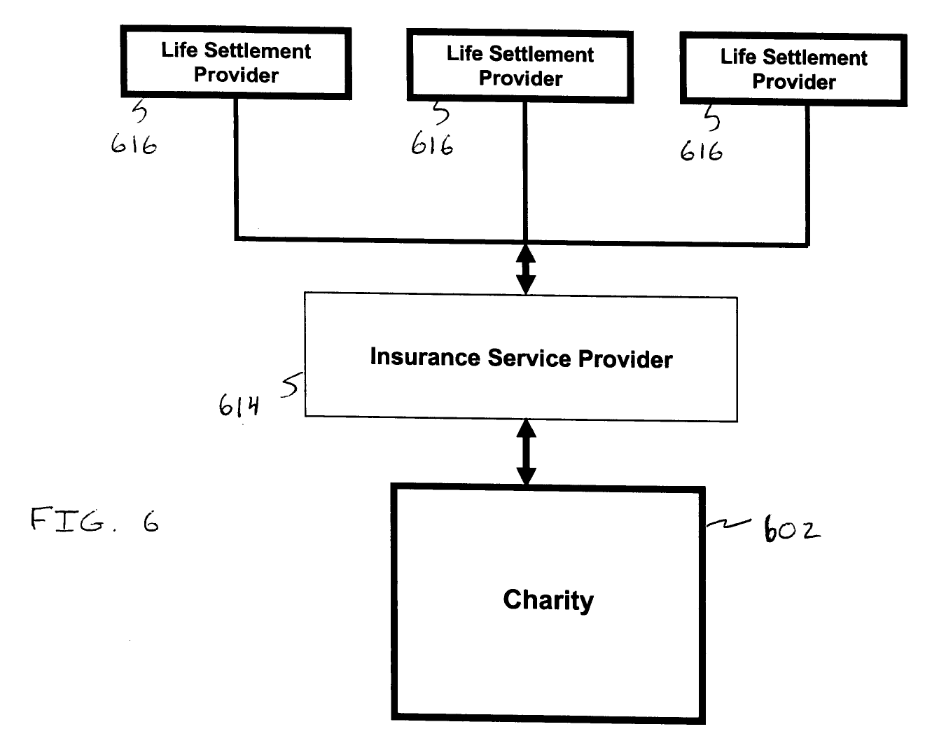

FIG. 6 is a schematic representation of an insurance service provider 614 obtaining competitive bids from multiple life settlement providers 616 on behalf of a charity 602.

In the illustrated implementation, the charity 602 is the owner and beneficiary of one or more life insurance policies. The life settlement providers 616 are entities interested in purchasing life insurance policies in life settlement transactions and typically pay the charity a cash sum greater than the policy's cash surrender value. Life settlement providers tend to be experienced in analyzing and valuing large-face-amount policies and also typically have in-house compliance departments to carefully review transactions. Generally they are backed by institutional funding sources.

In the illustrated implementation, the insurance service provider 614 markets the policies to multiple life settlement providers 616 in an attempt to seek favorable offers. The insurance service provider 614 helps the charity evaluate the offers against a number of criteria including offer price, stability of funding and privacy provisions.

In some implementations, separate life settlement investors (not shown) provide the capital or financing to a life settlement provider for a life settlement transaction. Life settlement investors may use their own capital to purchase the policies or may raise the capital from a wide range of investors through a variety of structures. The life settlement provider 616 enters into the transaction with the charity 602 and pays the charity when the life settlement transaction closes.

In the illustrated implementation, the insurance service provider 614 can: act as an advisor to the charity 102 in deciding whether to sell one or more of the charity's 602 policies; assist in valuing the charity's 602 policies; obtain relevant medical information regarding the individuals who are insured under such policies; evaluate whether the policies meet criteria for a life settlement; solicit offers from life settlement providers; review offers; complete the provider's closing packages, and perform other administrative and substantive functions.

The sales price of a life settlement can vary depending, among other things, on the insured's age and health at the time of the sale. In a typical life settlement, the sales price is between approximately 15% and 40% of the policy's full death benefit. For example, a 75 year-old individual may obtain a life insurance policy for $1,000,000 with policy premiums of $40,000 annually. After four years and after having paid $160,000 in premiums ($40,000/year*4 years=$160,000), the insured would be 79 years old. A typical cash surrender value of the policy under those circumstances might be approximately $40,000.

If the charity 602 no longer needed or wanted the policy, it may not wish to accept a $40,000 payoff for surrendering the policy, the charity 102 could instead sell the policy as a life settlement. Under the terms of the life settlement, the charity might receive, for example, 30% of the amount of the policy, i.e., the insurance proceeds that would be due on the insured individual's death. If the policy were set up to pay the basic insurance amount of $1,000,000, plus the sum of premiums paid to date (i.e., $160,000), then the death benefit that would be due if the insured died at the time of the life settlement would be $1,160,000 (i.e., $1,000,000+$160,000), 30% of which would be $348,000. In that scenario, the charity would be able to realize a higher return (i.e., $348,000) by selling the policy as a life settlement than it would by surrendering the policy (i.e., $40,000) to the insurance company.

It is desirable that the insurance service provider implement a competitive bidding process in connection with any potential life settlement. The interest of the life settlement buyer is to pay as low a price as possible in order to increase the rate of return. Conversely, the seller (charity) wants the highest price for the same reason. This process for finding a life settlement provider 616 improves the sales price that can be obtained by the charity 602.

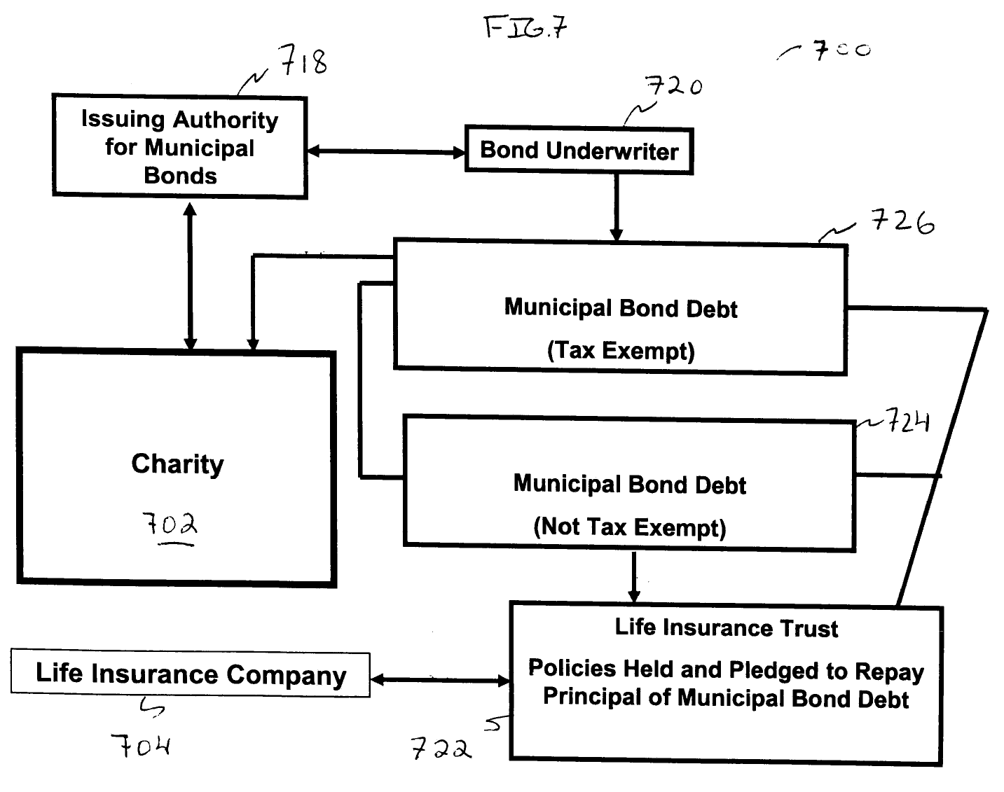

FIG. 7 is a schematic representation of entities 700 engaged in financing a capital project for a charity. In some implementations, the techniques engaged in by the illustrated entities enhance the charity's credit rating, thereby, reducing the charity's borrowing costs to fund the capital project. The illustrated entities 700 include the charity 702, a life insurance company 704, an issuing authority 718 for municipal bonds, a bond underwriter 720 and a life insurance trust 722. Also included in the discussion below, but not shown in FIG. 7, are one or more individuals to be insured.

In general, to finance the capital project, the charity 702 uses funds from a first municipal bond issue to fund premium payments for one or more life insurance policies. The charity 102 uses funds from a second municipal bond issue to finance a capital project that is likely related to its charitable purpose. Typically, the first municipal bond issue and the second municipal bond issue would be offered for purchase simultaneously by the bond underwriter 720. Proceeds from the life insurance policies are pledged to secure payment to holders of the municipal bonds from the second bond issue. That reduces the amount of risk associated with owning bonds from the second bond issue and, therefore, reduces the amount of interest the charity needs to pay for those bonds to attract purchasers (i.e., bond holders).

A bond is a certificate of debt (usually interest-bearing or discounted) that is issued by a government or corporation in order to raise money; the issuer may be required to pay a fixed sum annually until maturity and then a fixed sum to repay the principal. A municipal bond is a bond issued by local government authorities, including states or provinces, cities and/or their agencies. A municipal bond can be a general obligation of the issuing authority or can be secured by specified revenues. The municipal bond issuing authority may be, for example, a city, a county, a redevelopment agency, a school district, a publicly owned airport or seaport, or any other governmental entity (or group of government entities) below the state level.

Interest income received by holders of municipal bonds is often exempt from the federal income tax and from the income tax of the state in which they are issued, although municipal bonds issued for certain purposes may not be tax exempt. In general, the type of project or projects that are funded by a bond affects the taxability of income received on the bonds held by bond holders. Interest earnings on bonds that fund projects constructed for the public good are generally exempt from federal income tax, while interest earnings on bonds issued to fund projects partly or wholly benefiting only private parties, sometimes referred to as private activity bonds, may be subject to federal income tax.

Typically, the bond underwriter 720 is a financial institution (e.g., an investment bank or a commercial bank) which purchases the new issue of municipal bonds for resale.

The trustee of the life insurance trust 722 typically is a company that may be owned, for example, by an independent partnership, a bank, or other corporate fiduciary. The life insurance trust owns the life insurance policies, makes certain that the premiums are timely paid, collects the death proceeds and applies such proceeds to repaying the charity's debt.

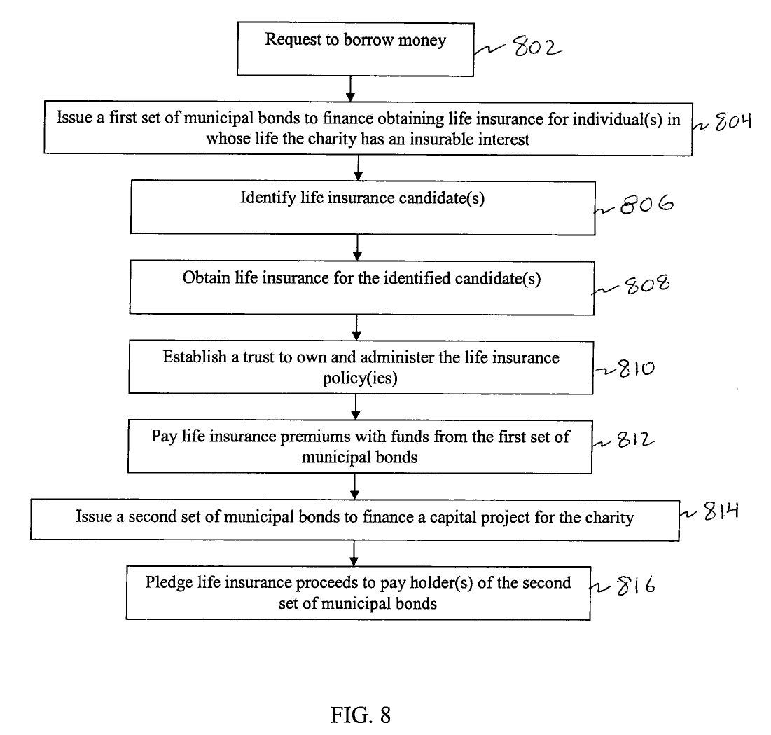

FIG. 8 is a flowchart of a method for financing a charity's capital project. In some implementations, the life insurance enhances the charity's credit rating and, thereby, lowers the charity's borrowing costs.

According to the illustrated implementation, the charity 702, desiring to fund a capital project related to one or more of its charitable purposes requests to borrow money funded, for example, through a municipal bond issue (block 802). As an example, the charity may be an assisted living facility and the capital project it desires funding for may be constructing a new building to provide assisted living.

In response to the charity's request, the municipal bond issuing authority issues a first set 724 of municipal bonds on behalf of the charity 702 (block 804). In the illustrated implementation, funds from the first set 724 of municipal bonds are earmarked to purchase life insurance policies for the benefit of the charity 702. As those funds are not earmarked for use related to a charitable purpose, they are not tax-exempt.

The first set 724 of municipal bonds are issued through the bond underwriter 720. The bond underwriter 720 may acquire the bonds either by negotiation with the issuing authority 718 or by award on the basis of a competitive bidding. Funds obtained from issuing the first set 724 of municipal bonds are provided to the charity 702 for use in connection with obtaining life insurance policies. More particularly, in the illustrated implementation, the charity 702 identifies life insurance candidates (block 806), obtains life insurance for the identified individual(s) (block 808), establishes a life insurance trust 722 to administer the life insurance policy(ies) (block 810), and pays the life insurance premiums with funds from the first set 724 of municipal bonds issued (block 816).

According to the illustrated implementation, the issuing authority 718 issues a second set 726 of municipal bonds to finance the charity's 702 desired capital project (block 814). Since the second set 726 of municipal bonds are related to a charitable purpose, those bonds are tax exempt.

The charity 702 pledges, for example, through the trust, to pay holder(s) of the second set 726 of municipal funds with proceeds from the life insurance policy(ies) (block 816). In some implementations, the charity may pledge those proceeds by using an instrument other than a trust. For example, a simple contract may be used.

Typically, interest due to holders of municipal bonds is keyed to the amount of risk involved in owning the municipal bonds. Higher risk municipal bonds generally pay more interest than comparable lower risk municipal bonds. Risk is viewed as being inversely proportional to the municipal bond's credit rating. Credit ratings are assigned by independent credit rating agencies to assess the credit worthiness of a municipal bond issue. Those credit ratings provide financial indicators to potential investors in the municipal bonds. The charity's credit ratings typically are determined based on the charity's financial history, current assets and liabilities. The charity may reduce its borrowing costs (i.e., the amount of interest it will need to pay to its municipal bond holders) by improving its credit rating.

In the illustrated implementation, as the second set 726 of municipal bonds is essentially secured by the life insurance proceeds, the amount of risk associated with owning those municipal bonds is lowered. Therefore, the amount of interest that the charity will have to pay to holders of the second set 726 of municipal bonds is reduced.

It generally is desirable that the sum of the policy proceeds expected from the life insurance represents a significant percentage of the amount of tax-exempt municipal bond debt carried by the charity, for example, 30%.

In some implementations, an insurance service provider may facilitate the interaction of a charity with a municipal bond issuing authority, a bond underwriter and/or a life insurance trust company.

A number of embodiments of the invention have been described. Nevertheless, it will be understood that various modifications may be made without departing from the spirit and scope of the invention.

For example, the order of steps described in connection with the foregoing methods may be modified. Accordingly, the inventive concepts should not be considered limited to the particular orders of steps described herein. Additionally, in certain implementations, a variety of parties may participate in the various techniques disclosed herein, including various advisors, consultants and financial organizations. The charity may be dedicated to any type of charitable purpose. Other types of debt instruments, besides municipal bonds, can be used in connection with enhancing the credit and, thereby, reducing the borrowing costs for a charity. Trusts may or may not be used to administer the policies on behalf of the charity.

Aspects of the foregoing techniques may be implemented with hardware, software or with a combination of hardware and software. For example, some aspects of the system can be implemented in computer programs executing on programmable computers. Each program can be implemented in a high level procedural or object-oriented programming language to communicate with a computer system. Furthermore, each such computer program can be stored on a storage medium, such as read-only-memory (ROM) readable by a general or special purpose programmable computer, for configuring and operating the computer when the storage medium is read by the computer to perform the functions described above.

Accordingly, other implementations are within the scope of this application and the following claims.

What is claimed is:

1. A method of funding a charity, the method comprising:
identifying an individual whose life represents an insurable interest to the charity;
obtaining an insurance policy to cover the identified individual's life;
funding premiums for the insurance policy from a funding source other than the insured individual; and
directing proceeds from the insurance policy for the benefit of the charity, pursuant to an agreement made approximately when the insurance policy was obtained.

2. The method of claim 1 wherein the proceeds are paid upon the insured individual's death.

3. The method of claim 2 wherein the proceeds comprise a basic insurance amount, plus a sum of the premiums paid as of the date that the proceeds are available.

4. The method of claim 3 wherein the proceeds further comprise interest on the sum of the premiums paid.

5. The method of claim 1 wherein the proceeds are paid upon a sale of the insurance policy by the charity to a third party.

6. The method of claim 1 comprising designating the charity a beneficiary of the insurance policy.

7. The method of claim 1 further comprising:
quantifying a value associated with the insurable interest; and
structuring the insurance policy in accordance with the quantified value.

8. The method of claim 7 wherein the life insurance policy is structured so that, upon the death of the insured individual, the charity receives sufficient capital to continue receiving the quantified value.

9. The method of claim 7 wherein the insurable interest is based on the insured individual's history of contributions to the charity.

10. The method of claim 9 wherein the contributions comprise periodic financial donations.

11. The method of claim 9 wherein the contributions comprise services volunteered to the charity.

12. The method of claim 11 wherein quantifying the insurable interest comprises:
assigning a value per unit of time to the services volunteered;
estimating how many units of time were volunteered by the insured individual; and
calculating a average value per unit of time received by the charity based on the services volunteered.

13. The method of claim 1 further comprising evaluating whether the individual is insurable.

14. The method of claim 13 wherein evaluating whether the individual is insurable comprises considering at least one of the characteristic from the following group: the individual's age, the individual's health and an estimated life expectancy for the individual.

14. The method of claim 1 wherein the funding source is an entity other than the charity.

15. The method of claim 1 wherein the charity has a donor advised fund for use as the funding source.

16. The method of claim 15 wherein use of the donor advised fund as the funding source is conditioned on advice from the donor.

17. The method of claim 15 wherein use of the donor advised fund as the funding source is conditioned on the donor advised fund being reimbursed if the insurance policy is sold or if the insured individual dies.

18. The method of claim 1 further comprising issuing a first set of municipal bonds to provide the funding source for the insurance policy premiums.

19. The method of claim 18 further comprising:
issuing a second set of municipal bonds to finance a capital project associated with the charity's charitable purpose; and
pledging the life insurance proceeds to pay holders of the second set of municipal bonds.

20. The method of claim 19 wherein the first set of municipal bonds is not tax-exempt and wherein second set of municipal bonds is tax-exempt.

21. The method of claim 1 further comprising selling an interest in the insurance policy to a third party as a life settlement.

22. A method of financing a charity's capital project, the method comprising:
issuing a first set of municipal bonds to provide a funding source for insurance policy premiums;
issuing a second set of municipal bonds to finance a capital project associated with the charity's charitable purpose; and
pledging the life insurance proceeds to pay holders of the second set of municipal bonds.

23. The method of claim 22 further comprising:
identifying an individual whose life represents an insurable interest to the charity;
obtaining an insurance policy to cover the identified individual's life; and
funding the insurance policy premiums with funds from the issuance of the first set of municipal bonds.

24. The method of claim 23 further comprising:
designating the charity as a beneficiary of the insurance policy so that policy proceeds are paid to the charity.

25. The method of claim 23 wherein policy proceeds are paid upon the insured individual's death and comprise a basic insurance amount, plus a sum of the premiums paid to date, plus interest on the sum of the premiums paid as of the date the policy proceeds are made available.

26. The method of claim 23 wherein policy proceeds are paid upon a sale of the insurance policy by the charity to a third party.

27. The method of claim 23 further comprising:
quantifying a value associated with the insurable interest; and
structuring the insurance policy in accordance with the quantified value.

28. The method of claim 27 wherein the life insurance policy is structured so that, upon the death of the insured individual, the charity receives sufficient capital to continue receiving the quantified value.

29. The method of claim 27 wherein the insurable interest is based on the insured individual's history of contributions to the charity.

30. The method of claim 29 wherein the contributions comprise periodic financial donations.

31. The method of claim 29 wherein the contributions comprise services volunteered to the charity, and
wherein quantifying the insurable interest comprises:
assigning a value per unit of time to the services volunteered;
estimating how many units of time were volunteered by the insured individual; and
calculating a average value per unit of time received by the charity based on the services volunteered.

32. The method of claim 23 further comprising evaluating whether the individual is insurable by considering at least one of the characteristic from the following group: the individual's age, the individual's health and an estimated life expectancy for the individual.

33. The method of claim 23 further comprising selling an interest in the insurance policy to a third party as a life settlement.

34. A method of facilitating the funding of a charity, the method comprising:
identifying an individual whose life represents an insurable interest to the charity;
obtaining an insurance policy to cover the identified individual's life on behalf of the charity;
arranging for the funding of insurance policy premiums from a funding source other than the insured individual; and
arranging for the payment of proceeds from the insurance policy for the benefit of the charity.

35. The method of claim 34 comprising arranging for the charity to be designated a beneficiary of the insurance policy.

36. The method of claim 34 further comprising:
quantifying a value associated with the insurable interest; and
structuring the insurance policy in accordance with the quantified value.

37. The method of claim 36 wherein the life insurance policy is structured so that, upon the death of the insured individual, the charity receives sufficient capital to continue receiving the quantified value.

38. The method of claim 36 wherein the insurable interest is based on the insured individual's history of contributions to the charity.

39. The method of claim 34 further comprising arranging for an evaluation of whether the individual is insurable with consideration to at least one of the characteristics from the following group: the individual's age, the individual's health and an estimated life expectancy for the individual.

40. The method of claim 34 wherein obtaining the insurance policy comprises:
soliciting competitive bids on behalf of the charity from more than one insurance company; and
assisting the charity to evaluate bids received.

41. The method of claim 34 further comprising:
obtaining competitive bids from more than one life settlement provider to sell an interest in the insurance policy to a third party; and
assisting the charity to evaluate bids received.

42. The method of claim 33 wherein arranging for the payment of proceeds from the insurance policy for the benefit of the charity is performed approximately when the insurance policy is obtained.
